(19) United States
(12) Patent Application Publication
(10) Pub. No.: US 2010/0018163 A1
(43) Pub. Date: Jan. 28, 2010

(54) Tubular bag sealing system

(76) Inventors: Cliff Broderick, Newburgh, NY (US); Mark Gaeta, Fort Salonga, NY (US)

Correspondence Address: Thomas A. O'Rourke;Bodner & O'Rourke, LLP, 425 Broadhollow Road, Suite 108, Melville, NY, 11747, US

(21) Appl. No.: 12/456,041

(22) Filed: Jun. 10, 2009

Related U.S. Application Data
(60) Provisional application No. 61/131,565, filed on Jun. 10, 2008.

(51) Int. Cl. B65B 3/02; B31B 19/00

(52) U.S. Cl. 53/452; 493/186

(57) ABSTRACT

The invention provides a system of forming one or more bags from a tubular sleeve of film. The invention further provides a system that takes a tubular film, fills it and forms individual bags without generating as much dust from the filling process as current systems. The bottom end of the tubular film is sealed by any suitable method including but not limited to heat seal, adhesive seal, mating seal, etc. Product enters the film via the top end, opposite the sealed bottom end, and ceases entering once a suitable amount has been deposited at which point a second seal encapsulates said products in said package. The package can then be separated from the remainder of the tubular film and the process can continue forming more packages of product.

This application claims priority on U.S. Provisional Patent Application Ser. No. 61/131,565 filed Jun. 10, 2008 the disclosures of which are incorporated herein by reference.

### FIELD OF INVENTION

The present invention relates to sealable and/or resealable containers used primarily for bulk packaging more particularly the present invention relates to bulk packaging of pharmaceuticals and the like and more particularly materials that are in the form of powders.

### BACKGROUND OF THE INVENTION

Pharmaceuticals, cosmeceuticals and nutraceuticals are frequently packaged in bulk for shipment from the place of manufacture to another location. The other location may be where the composition undergoes further formulation or where the composition is packaged in smaller quantities for users, etc.

Currently many bulk shipments of pharmaceuticals is done in drums whether plastic or metal or in bags, usually flexible bags made of plastic, or paper or a multi layer composite where at least one layer is a plastic and at least one layer is paper. During filling, these bags, no matter what the composition or structure of the bags, are usually filled individually. By individually is meant each individual bag is filled in turn by a process at the filling station. The bag then can be sealed in place or moved to a sealing station for sealing. The bag can be sealed by a variety of means including a heat seal, a sewn seal or other suitable sealing methods.

One of the problems with the prior packaging system is that a great deal of product dust can be generated by the process. As product flows into one end of the bag, product dust is generated and becomes airborne. Following the filling step, if the bag is manipulated while open including for sealing, dust is frequently a by-product of the manipulation. If the bag is transported to the sealing station where the top of the bag is sealed, the transportation step can jostle the bag and cause product dust generation. Whether the top is sealed by a heat seal or by sewing or by other means, the manipulation of the bag can generate product dust during the manufacturing process.

Product dust generated by the packing process and other steps in the manufacturing process have been the subject of several recent studies. Besides damage the dust can cause to the lungs when the dust is inhaled there is also the problem of workers receiving undesired doses of the pharmaceuticals, neutraceuticals or cosmaceuticals. The ingestion of some of the pharmaceutical dust can be very damaging to the workers. For example in one recent instance it was found that the workers in a pharmaceutical plant manufacturing birth control pills had inordinately high levels of estrogen. These high estrogen levels were due to physical contact with the ingredients used in manufacturing the birth control pills, either through breathing the dust or from physical contact with the workers skin.

As a result, there is a need for an improved packaging system and a package that reduces the risk of product contact with workers during the filling and sealing process.

### OBJECTS OF THE INVENTION

It is an object of the present invention to provide an improved system for bulk packaging pharmaceuticals, nutraceuticals, cosmaceuticals and the like.

It is also an object of the invention to provide an improved bulk package for containing pharmaceuticals, nutraceuticals, cosmaceuticals and the like.

It is another object of the invention to provide a tubular bag for use in bulk packaging of pharmaceuticals, nutraceuticals, cosmaceuticals and the like.

It is a still further object of the invention to provide a system that reduces dust generation in the bulk packaging of pharmaceuticals, nutraceuticals, cosmaceuticals and the like.

It is still another object of the invention to provide a bagging system for bulk powdery material that reduces dust generation.

It is a further object of the invention to provide a bagging system that reduces worker contact with powdery product that is being packaged.

### SUMMARY OF THE INVENTION

The present invention is directed to a system of forming one or more bags from a tubular sleeve of film. The invention is also directed to a system that takes a tubular film and fills and forms individual bags without generating dust from the filling process as much as current systems. The film used in the present invention may be a cast film that has been, for example, folded and sealed along the edge opposite the fold to form a tubular film. However the film is preferably a blown film of one or more layers that have been coextruded. The film could also be laminate of two or more sheets of film. The sheets may be sealed at the opposite outer edges to form a tube or the film could be folded over and the two sides sealed together to form a tube. The film could be any suitable thickness. However, in a preferred embodiment the film could have a thickness that ranges from about 0.1 mils to about 5 mils. In a more preferred embodiment the film could have a thickness that ranges from about 0.5 mils to about 3 mils.

The tube of film has at least one sidewall. One end of the tube is sealed to form a bag bottom. Sealing consists of creating a seal in order to prevent the packaged product from being released from the package unless the seal or the sidewall is broken. The product is deposited into the bag through the end opposite the sealed end. In one embodiment, the tubular film may, for example, be extruded through a ring or circular die where there is an open area in the center of the die. Through the open area of the die there may be an outlet pipe from the manufacturing equipment or other means for providing the product to be packaged into the tubular film having one or more sidewalls and a sealed bottom. This arrangement prevents product dust from easily escaping into the air from the bag. When the bag is filled the appropriate amount, the bag is sealed. When the suitable amount of product has been deposited in the bag the outlet will cease depositing product in the bag. At that point a seal is formed between the product containing portion of the tubular film and the remainder of the tubular film. In the same step or in a different step the sealed bag is then separated from the remainder of the tubular film. The bag may be sealed by a heat seal from one side to the other side, including but not limited to an axis along the transverse to the sidewalls of the tubular film. Other types of seals may be formed instead. The seal so formed becomes the seal for the top of the first bag. The first heat seal may form the top seal of the first bag and the bottom seal of the second bag. Alternatively, the first seal may be the top of the first bag and a separate seal may be formed that constitutes the bottom seal of the second bag. In this instance the two bags may be separated or they may be bound together at the seals or by an area of tubular film between the two seals. This arrangement of seals can proceed over the length of the tubular film thereby forming a series of bags that are either connected together or as individual bags.

Besides a heat seal in another embodiment the bag may be sealed by an adhesive along the length of the tubular film. A strip of adhesive is applied to the inside surface of the bag by a second outlet member and sealing is effected by contacting the surface having the adhesive strip with a second inside surface on the opposite side of the tubular film. The opposite side of the inside surface may also be provided with an adhesive if desired. The adhesive seal so formed can be the initial bottom seal, it can be the seal for the top of the first bag and/or can form the bottom seal of the second bag.

The bag can be made resealable by having an embodiment that uses a releasable adhesive that can be resealed or by means of a mating seal. The mating seal can be a pair of generally parallel beads formed along the inner surface of the one side of the bag. There are also one or more beads formed on the inside surface of the opposite wall of the bag. One bead is pushed between the two opposite beads on the inner opposite wall to form a reclosable bag. A mating seal can also be accomplished by interlocking rib and groove elements. In this case the mating seal would include at least one rib on the inside surface of one side of the tubular film and at least one mating groove on the opposite inside surface of the tubular film. When the two inside surfaces are pressed together, the rib is positioned inside the groove forming a seal that retains the bag in a closed position.

### BRIEF DESCRIPTION OF THE DRAWINGS

FIG. 1: is a perspective view of the system of the present invention in which the blown film is produced through an extruding process and then product is packaged within the tubular film.

FIG. 2: is a perspective view of the bag system of the present invention.

FIG. 3 is a close up of the side view of the bag sleeve.

FIG. 4: is a perspective view of the system of FIG. 2 with a sealed bag separated from the bottom of the next bag.

FIG. 5: is a close up of the rib-groove interlocking mating seal FIG. 6: is a profile view of a rounded rib element for a mating seal.

FIG. 7: is a profile view of the mating groove element to the rib element in FIG. 6.

FIG. 8: is a perspective view of the bag system of the present invention for an embodiment in which only heat or adhesive seals are used.

FIG. 9: is a perspective view of the bag system of the present invention for an embodiment in which a heat or adhesive seal is used to bond the bottom of the bags and a mating seal is used to bond the top of the bags.

FIG. 10: is a profile view of the elements of an interlockable mating seal which is not in the sealed position.

FIG. 11: is a profile view of the elements of the interlockable mating seal in FIG. 10 when it is in the sealed position.

FIG. 12: is a perspective view of the bag system of the present invention in which a laminated film formed from a first flat sheet and a second flat sheet or a film consisting of a single sheet that has been folded over so that the two opposite edges are in a face to face relationship is used to package the product.

FIG. 13: is a profile view of the bag system of FIG. 12.

FIG. 14: is a perspective view of the bag system of the present invention in which individual heat seals are used to seal both the top and bottom of the bags and another heat seal is used in the area located between the bags where they will be separated.

### DETAILED DESCRIPTION OF THE INVENTION

The system and resulting bag of the present invention preferably entails a tubular film such as a blown film process or tubular film extrusion. The film, however, can include a flat sheet of film that has been formed into a tubular sleeve. The process may, for example, involve extrusion of a plastic through a circular die, followed by “bubble-like” expansion. The principal advantages of manufacturing film by this process include the ability to produce tubing (both flat and gusseted) in a single operation. Another benefit is the regulation of film width and thickness by control of the volume of air in the bubble, the output of the extruder and the speed of the haul-off. Blown films also eliminate end effects such as edge bead trim and non-uniform temperature that can result from flat die film extrusion. Finally, blown films have the capability of biaxial orientation (allowing uniformity of mechanical properties). Blown Film Extrusion can be used for the manufacture of co-extruded, multi-layer films for high barrier applications such as food packaging.

In the manufacture of a blown film a plastic melt is extruded through an annular slit die, usually vertically, to form a thin walled tube. Air is introduced via a hole in the center of the die to blow up the tube like a balloon. Mounted on top of the die, a high-speed air ring blows onto the hot film to cool it. The tube of film then continues upwards, continually cooling, until it passes through nip rolls where the tube is flattened to create what is known as a ‘lay-flat’ tube of film. This lay-flat or collapsed tube is then taken back down the extrusion ‘tower’ via more rollers. On higher output lines, the air inside the bubble is also exchanged. This is known as IBS (Internal Bubble Cooling). The lay-flat film is then either kept as such or the edges of the lay-flat are slit off to produce two flat film sheets and wound up onto reels. If kept as lay-flat, the tube of film is made into bags by sealing across the width of film and cutting or perforating to make each bag. This is done either in line with the blown film process or at a later stage. Typically, the expansion ratio between die and blown tube of film would be 1.5 to 4 times the die diameter. The drawdown between the melt wall thickness and the cooled film thickness occurs in both radial and longitudinal directions and is easily controlled by changing the volume of air inside the bubble and by altering the haul off speed. This gives blown film a better balance of properties than traditional cast or extruded film which is drawn down along the extrusion direction only. The film could be any suitable thickness. In a preferred embodiment the film could have a thickness that ranges from about 0.1 mils to about 5 mils and in a more preferred embodiment the film could have a thickness that ranges from about 0.5 mils to about 3 mils.

Polyethylenes (HDPE, LDPE, and LLDPE) are the most common resins in use, but a wide variety of other materials can be used as blends with these resins or as single layers in a multi-layer film structure. These include polypropylene, polyamides, ethylene vinyl alcohol. In some cases, these materials do not gel together, so a multi-layer film would delaminate. To overcome this, small layers of special adhesive resins are used in between. These adhesive layers are sometimes called “tie layers.”

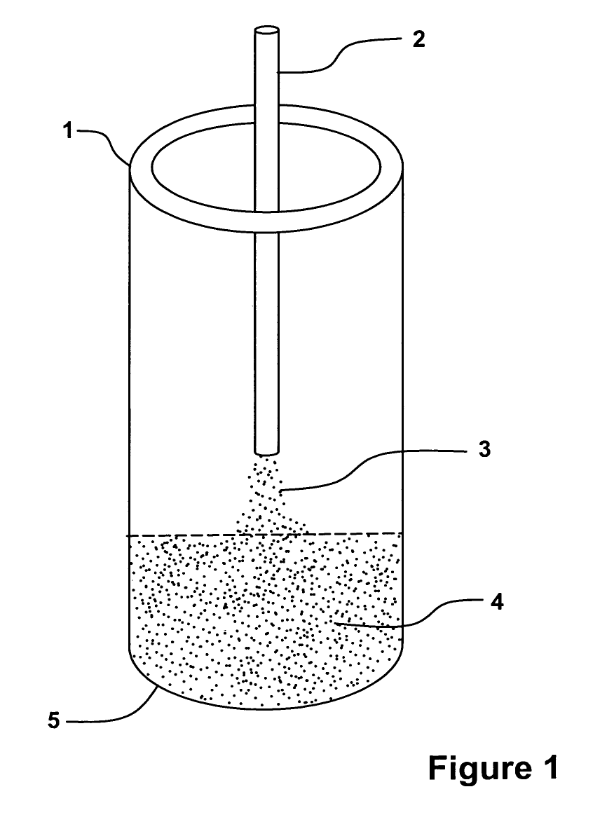

As shown in FIG. 1, in the present invention the blown film can be extruded through an annular slit die 1 in the form of a ring to form a thin walled tube. Once the tubular film is produced via the process described above, the end 5 is sealed by an appropriate means such as a heat seal, mating seal, an adhesive seal, etc. Through the open area of the die 1 there may be a pipe 2, an orifice, or other suitable means for providing the product to be packaged 3 into the tubular film. When the bag is filled with the desired amount of product 4, the product outlet 2 stops depositing product into the bag. At that point a seal is formed between the product containing portion of the tubular film and the remainder of the film. The die or other means of forming the seal, such as a heated blade, not only seals the end 5 of the bag but can, if desired, also separate one filled bag from the remainder of the tubular film; the formation of the seal and the separation from the rest of the tubular film can occur in the same step or in a different step. Another seal must then be initiated to form the bottom of the next bag in the length of the tubular film.

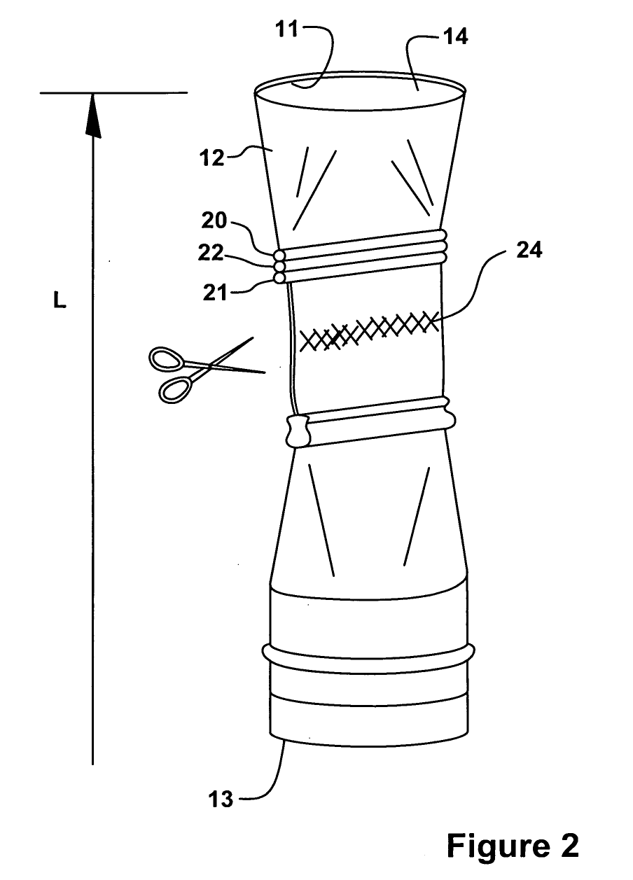

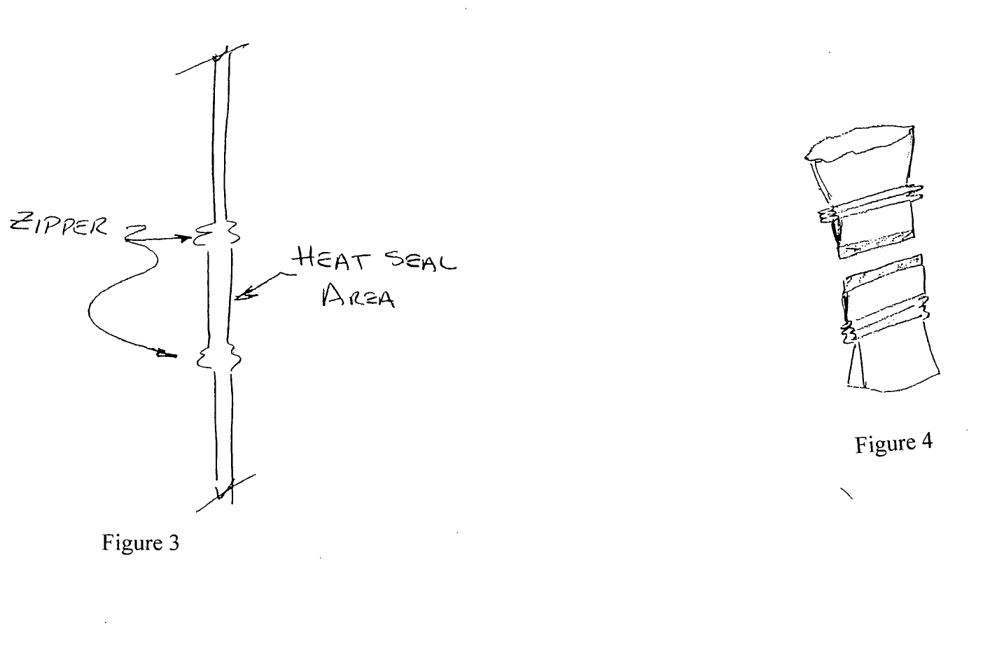

As seen in FIG. 2, there is a length “L” of film 10. The length L can vary depending on the amount of product to be package or based on other considerations. The length of film has an inner surface 11 and an outer surface 12. The length of the film can vary depending on the number of bags. FIG. 2 shows a tubular, blown film, but it will be appreciated that a laminated film formed from a first flat sheet and a second flat sheet that are laminated together at two opposite edges can form the substrate for the bag used in the present invention. One end 13 of a length of blown tubular film is sealed by an appropriate means such as a heat seal, mating seal, an adhesive seal, or any other suitable sealing method. Product enters the opposite end 14 of the tubular film. When the appropriate amount of product enters the open end of the tubular film, a seal is formed. This seal again can include a heat seal, mating seal, an adhesive seal, or any other suitable sealing method. Once the top seal is formed, the film can be cut in the appropriate length to create the bag. Another seal is then needed to form the bottom of the next bag in the length of the tubular film.

Although FIG. 1 shows a process in which the tubular film is manufactured in the same process by which the product is packaged, the end 14 of the tubular film opposite the open end 13 can be an open end that is “free standing.” In this embodiment a roll of tubular film is formed in a separate process from the packaging of the product. As seen in FIG. 2, the bottom end 13 of the roll of tubular film or a portion thereof will first be sealed by any suitable means including but not limited to heat, an appropriate adhesive or a mating seal, etc. Product will then enter via the open end 14, i.e. the end of the film opposite end 13. When a suitable amount of product has been sent to the bag, the bag is sealed. That bag is then separated from the remainder of the tubular film which can be used for the remainder of the bags. In another embodiment an initial step can include separating a certain limited length of the tubular film from the remainder of the roll and then sealing end 13 and following the packaging procedure described above. Once that limited length of tubular film is filled and separated into individual bags another certain limited length can be separated from the roll of tubular film and be filled accordingly.

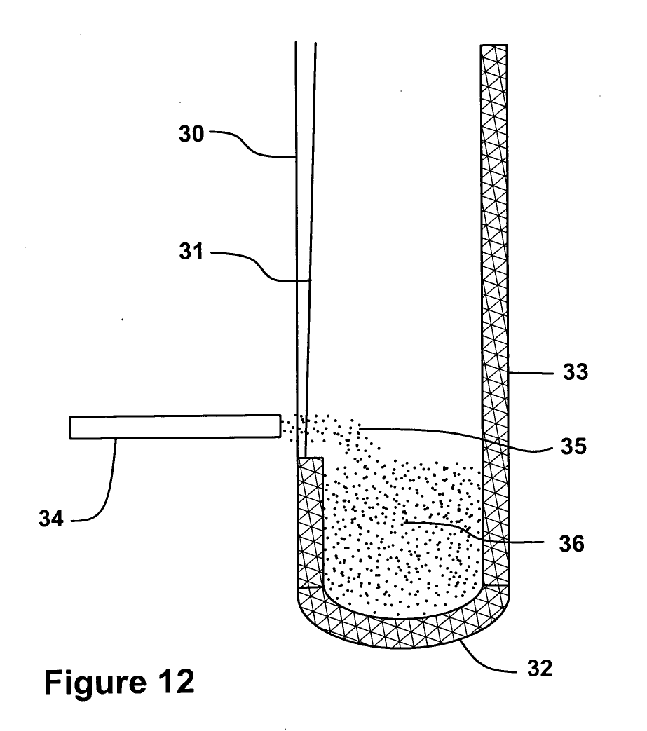

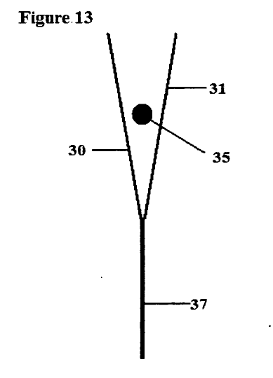

As seen in FIGS. 12 and 13, yet another embodiment can include a laminated film formed from a first flat sheet 30 and a second flat sheet 31 that are laminated together along one edge 35. The two sheets can be laminated together at one of the outer edges 33. Alternatively, the film may be a single sheet that has been folded over so that the two opposite edges 30 and 31 are in a face to face relationship. The bottom end 32 of the sheet or sheets can be sealed by a heat seal, an adhesive seal, a mating seal, or any other suitable method of sealing. The product 35 can then be discharged horizontally from the manufacturing equipment 34 into the space between the free edges in a face to face relationship. After a suitable amount of product has been inserted the sleeve will continue its motion downwardly and the sidewall 37 will be sealed so that the next bag may be formed and then filled. Once the film is filled to the appropriate amount the bag is sealed from one sidewall to the other sidewall by any suitable means to form an individual sealed bag. After the “top” seal is formed, the sealed bag can be separated from the remainder of the two sheets or from other bags that have been formed in the same manner. Another seal is then needed to form the bottom of the next bag in the length of the film.

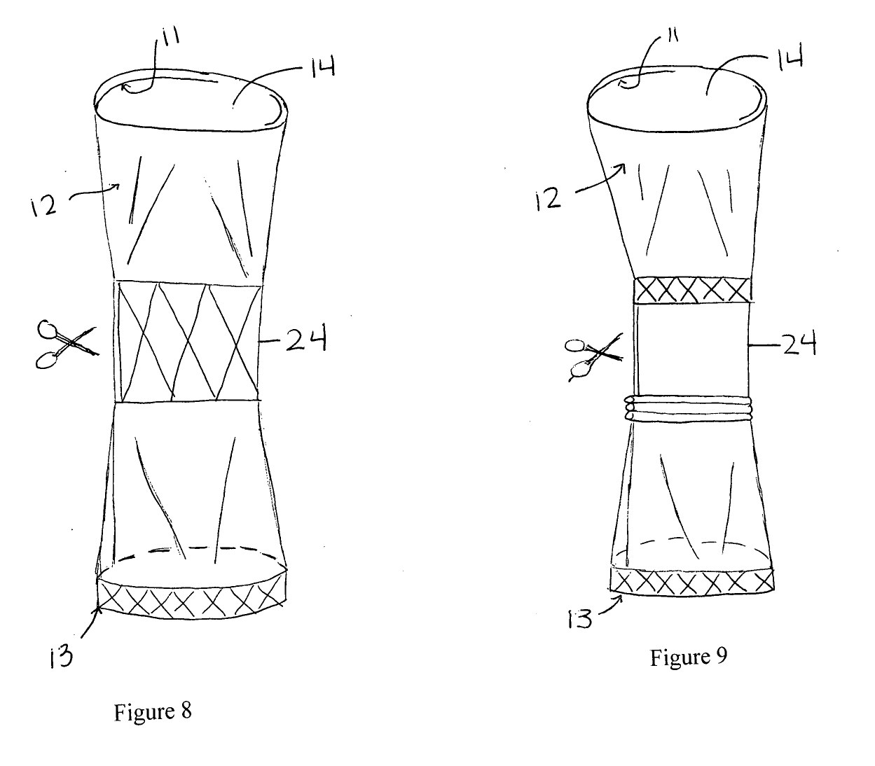

There are various types of seals that can be used to bond the bottom end 13 of the tubular film and then subsequently seal the top of that bag as well as the bottom of the next bag and so on depending on the length of the tubular film used. One type of seal that can be utilized is a heat seal in which heat is applied along the length of the tubular film under pressure that melts the bag and welds the two sides of the bag together. If a heat seal is used to seal the top of a bag after the appropriate amount of product has entered the open end 14 of the tubular film, it can constitute the top seal of that bag as well as the seal at the bottom of the next bag in the length of tubular film. This can be seen in FIG. 8 where 24 represents the heat seal which can constitute the top seal of the bottom bag and the bottom seal of the upper bag.

Another embodiment can employ an adhesive seal in order to bond the top and bottom of the bags. A machine will apply adhesive to the inside surface of one side of the bag and when pressure is applied allowing the surface having the adhesive strip to come into contact with the surface on the opposite side of the tubular film, the seal will result. There are various adhesives that can be used in this application. One such adhesive is a hot melt adhesive which is solid at room temperature but when heated becomes a liquid capable of quickly bonding the plastic. Another adhesive is a heat-activated adhesive that can be applied to the plastic bags in a thin non-tacky film which when heat activated becomes tacky and can remain tacky even after cooling. Yet another adhesive that can be used is a pressure sensitive adhesive which forms a bond when pressure is applied to marry the adhesive with the adherent; no water, solvent or heat is needed to activate this adhesive. As an alternative to an adhesive a cohesive also known as a cold-seal adhesive, can be applied to opposite sides of the inside of the bag. When pressure is applied the intermolecular attraction between like-molecules will act to unite the two inside surfaces of the bag. If an adhesive seal is used to seal the top of a bag after the appropriate amount of product has entered the open end 14 of the tubular film, it can constitute the top seal of that bag as well as the seal at the bottom of the next bag in the length of tubular film. This can be seen in FIG. 8 where 24 represents the adhesive seal which can constitute the top seal of the bottom bag and the bottom seal of the upper bag.

In an alternative embodiment, instead of sealing the ends with a heat seal or an adhesive seal, a mating seal can be employed. In a preferred embodiment, there are two generally parallel beads 20 and 21 formed on the inside surface of the tubular film and at least one bead 22 on the opposite inside surface of the tubular film. When the bag is formed of two separate sheets one sheet will have the two beads and the second sheet will have at least one bead. The two surfaces of the sheets that have the beads become the inner surfaces of the bag when the sheets are formed into a bag by sealing two opposite parallel edges. As the two inside surfaces are pressed together, the single bead is positioned so that it becomes positioned between the double bead members forming a resealable seal that retains the bag in a closed position where the bag has been filled. In another embodiment, the beads can be formed at the ends of the tubular film when the heat seal is formed. The tubular film can have these beads or ribs at various locations along the length of the tubular film. This permits a first bag to be filled with product. The bag is then sealed by positioning the single bead between the dual beads. The portion of the tubular film above the sealed beads can be cut off. In a preferred embodiment, the bottom of the next bag is formed by another set of beads and a cutting means separates the filled bag from the next bag as seen in FIGS. 2 and 4. In another embodiment there can be double beads on both insides surfaces of the tubular film which may make positioning the beads an easier task.

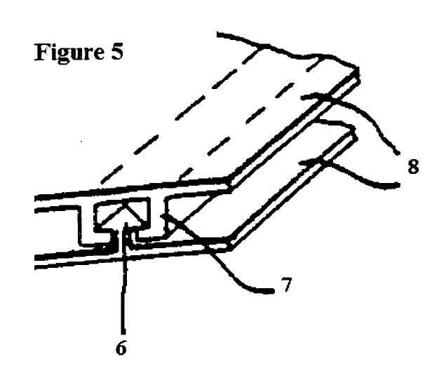

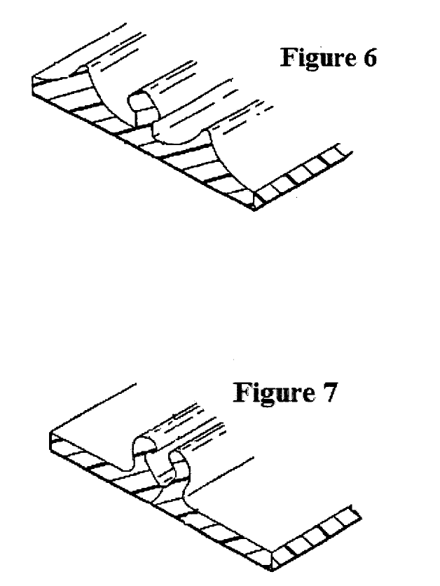

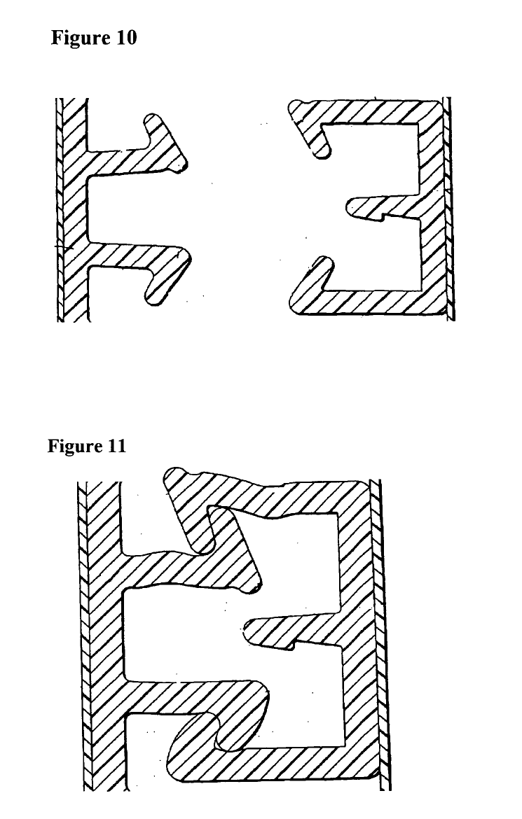

Another mating seal can be accomplished by interlocking rib and groove elements. A strip will comprise a web which has longitudinally extending interlockable profiles 6 and 7, as seen in FIG. 5. Any suitable mating arrangement can be used in an embodiment. The mating seal can include a single arrow-shaped rib and a mating groove. However, the shape of the rib is not limited to an arrow-shape it just has to be shaped and sized to fit into the groove profile. In a preferred embodiment, there is a rib on the inside surface of one side of the tubular film and a mating groove on the opposite inside surface of the tubular film. When the bag is formed of two separate sheets one sheet containing the rib and the other containing the groove, the two surfaces containing the rib and groove become the inner surfaces of the bag when the sheets are formed into a bag by sealing two opposite parallel edges. As the two inside surfaces are pressed together, the rib is positioned inside the groove forming a lock that retains the bag in a closed position. Flanges 8 can be used to pull the zipper profiles apart, making them resealable. FIG. 6 demonstrates a profile view of a rounded rib element, while FIG. 7 demonstrates a profile view of the mating groove element. Numerous different embodiments can be accomplished which include varying interlockable profile seals. FIG. 10 and FIG. 11 demonstrate the profile views of a more complex interlockable profile seal.

If desired, the mating seals can be any other suitable locking members known in the art. In addition, if desired, the mating seals can make the bag resealable so that some product can be removed and the bag can be reclosed keeping the product protected from the environment. In this embodiment, the sealed portion 24 between the two mating seals can be cut away leaving the reclosable mating seals. FIG. 2 shows the heat seal area that is between the two mating seals that can be removed by cutting or other means. When the bag is empty, the mating seals at each end of the bag are closed and the center portion may be heat sealed by a hand unit or other means.

Another embodiment can have the open end 13 of the tubular film sealed by a heat or adhesive seal before the product enters the tubular film via the opposite open end 14. The product can then be discharged from the manufacturing equipment into the open end 14 of the tubular film and when a suitable amount of product has been sent into the bag, the bag is sealed by a mating seal. The seal for the bottom of the consecutive bag may be a heat or adhesive seal and when that bag is filled with a suitable amount of product, the bag may be sealed by a mating seal. This chain of bags can continue for the length L of the tubular film which can vary depending on the amount of product to be packaged or based on other considerations. This embodiment can be seen in FIG. 9.

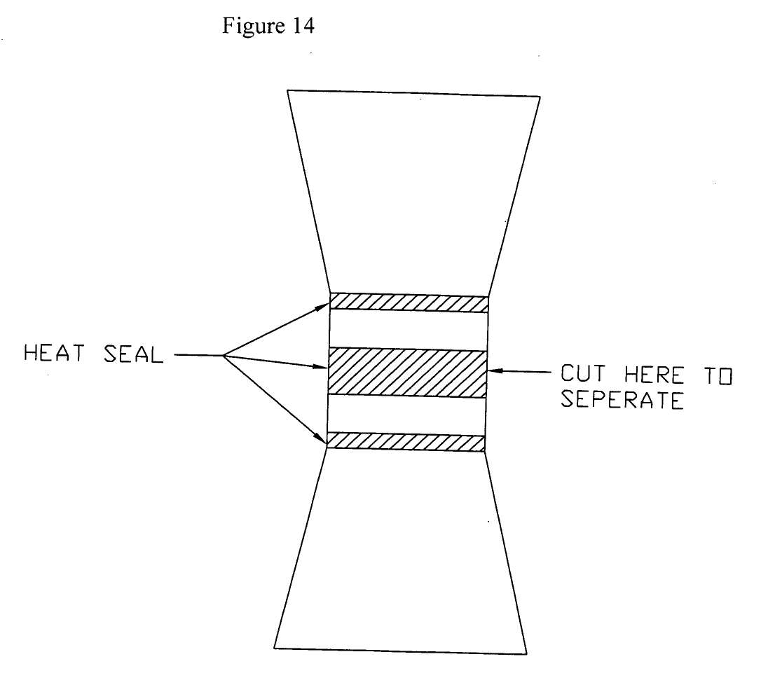

As seen in FIG. 14, yet another embodiment can include only heat seals. The open end 13 of the tubular film can be sealed by a heat seal before the product enters the tubular film via the opposite open end 14. The product can then be discharged from the manufacturing equipment into the open end 14 of the tubular film and when a suitable amount of product has been sent into the bag, the bag is sealed by a heat seal. The seal for the bottom of the next consecutive bag will also include a heat seal and when that bag is filled with a suitable amount of product, the bag is sealed by a heat seal. The area between the two bags will include a heat seal as well which will encapsulate residual product and also serve as the location where the operator may cut to separate the two bags. In a preferred embodiment the heat seals used to seal the top and bottom of the bags will be smaller than the heat seals located between the bags, which serve to encapsulate residual product. This chain of bags can continue for the length L of the tubular film. In a still further embodiment one or more of the heat seals could be replaced with one or the other seals discussed herein.

I claim:

1. A method of forming a plurality of packages comprising:
forming a sleeve of a thermoplastic film said sleeve having at least one sidewall and a first end,
sealing said first end to form a bottom of said package,
filling at least a portion of said sleeve with product at an end of said sleeve opposite said first end,
forming a second seal opposite said first seal to thereby encapsulate said product in said package,
separating said package from said sleeve such that separating said package from said sleeve forms a third seal at an end of said sleeve to form a bottom of a second package,
filling at least a portion of said sleeve with product at an end of said sleeve opposite said second end,
forming a fourth seal opposite said third seal to thereby encapsulate said product in said second package,
separating said second package from said sleeve such that separating said package from said sleeve forms a fifth seal at an end of said sleeve to form a bottom of a third package.

2. The process according to claim 1 wherein the said product comprises a pharmaceutical.

3. The process according to claim 1 wherein the said product comprises a cosmeceutical.

4. The process according to claim 1 wherein the said product comprises a nutraceutical.

5. The process according to claim 1 wherein said sleeve has more than one sidewall.

6. The process according to claim 1 wherein said seals are heat seals.

7. The process according to claim 1 wherein said seals are adhesive seals.

8. The process according to claim 1 wherein said seals are mating seals.

9. The process according to claim 8 wherein said mating seals consist of at least two parallel beads formed on an inside surface of the film and at least one bead on an opposite inside surface of the tubular film such that when the two inside surfaces of said film are pressed together the single bead is positioned between the double bead members forming a resealable seal that retains the bag in a closed position.

10. The process according to claim 8 wherein said mating seals consist of at least one rib on an inside surface of one side of the film and a mating groove on an opposite inside surface of the film such that when the two surfaces containing the rib and groove elements are pressed together the rib is positioned into the groove forming a seal that retains the bag in a closed position.

11. The process according to claim 1 wherein said seals forming the bottom of said packages consist of a heat seal and said seal sealing said product into said package consist of mating seals.

12. The process according to claim 1 wherein said seals forming the bottom of said packages consist of an adhesive seal and said seals encapsulating said product consist of mating seals.

13. A method of forming a plurality of packages comprising:
providing a sleeve of a thermoplastic film said sleeve having at least one sidewall said sleeve having an inside surface and an outside surface, said sleeve having at least one end,
sealing said end of said sleeve,
filling at least a portion of said sleeve with a product to be packaged,
sealing said sleeve after the product has been inserted into said sleeve to form a first package,
separating said package from said sleeve such that said step of separation forms a seal on said sleeve for a bottom of a second package,
filling at least a portion of said sleeve with product,
sealing said sleeve after the product has been inserted into said sleeve to form a second package.

14. The process according to claim 13 wherein the said product comprises a pharmaceutical.

15. The process according to claim 13 wherein the said product comprises a cosmeceutical.

16. The process according to claim 13 wherein the said product comprises a nutraceutical.

17. The process according to claim 13 wherein said sleeve has more than one sidewall.

18. The process according to claim 13 wherein said seals are heat seals.

19. The process according to claim 13 wherein said seals are adhesive seals.

20. The process according to claim 13 wherein said seals are mating seals.

21. The process according to claim 20 wherein said mating seals consist of at least two parallel beads formed on an inside surface of the film and at least one bead on an opposite inside surface of the tubular film such that when the two inside surfaces of said film are pressed together the single bead is positioned between the double bead members forming a resealable seal that retains the bag in a closed position.

22. The process according to claim 20 wherein said mating seals consist of at least one rib on an inside surface of one side of the film and a mating groove on an opposite inside surface of the film such that when the two surfaces containing the rib and groove elements are pressed together the rib is positioned into the groove forming a seal that retains the bag in a closed position.

23. The process according to claim 13 wherein said seals which seals the end of said sleeve and said seal which separates said package from said sleeve consist of a heat seal and said seals which seals said sleeve after the product has been inserted into said sleeve consist of mating seals.

24. The process according to claim 13 wherein said seals which seals the end of said sleeve and said seal which separates said package from said sleeve consist of an adhesive seal and said seals which seals said sleeve after the product has been inserted into said sleeve consist of mating seals.

25. A method of forming a package comprising:
extruding a sleeve of a thermoplastic film from a ring die said ring die having at least an area in a center portion thereof for receiving an outlet for dispensing a product into said sleeve, said outlet passing through the center portion of said ring die,
forming a seal at an end of said sleeve opposite said ring die,
filling at least a portion of said sleeve with said product through said outlet,
forming a seal above the portion of the sleeve containing said product to form a package.

26. The process according to claim 25 wherein the said product comprises a pharmaceutical.

27. The process according to claim 25 wherein the said product comprises a cosmeceutical.

28. The process according to claim 25 wherein the said product comprises a nutraceutical.

29. The process according to claim 25 wherein said seals are heat seals.

30. The process according to claim 25 wherein said seals are adhesive seals.

31. The process according to claim 25 wherein said seals are mating seals.

32. The process according to claim 31 wherein said mating seals consist of at least two parallel beads formed on an inside surface of the film and at least one bead on an opposite inside surface of the tubular film such that when the two inside surfaces of said film are pressed together the single bead is positioned between the double bead members forming a resealable seal that retains the bag in a closed position.

33. The process according to claim 31 wherein said mating seals consist of at least one rib on an inside surface of one side of the film and a mating groove on an opposite inside surface of the film such that when the two surfaces containing the rib and groove elements are pressed together the rib is positioned into the groove forming a seal that retains the bag in a closed position.

34. A method of forming a plurality of packages comprising:
forming a laminated film from a first flat sheet and a second flat sheet that are laminated together,
sealing together the bottom ends of the said two sheets,
filling at least a portion of said laminated film via an outlet in which the product is discharged horizontally into the space between the said two sheets on the side which was not laminated together starting from the end of the said two sheets where the said bottom ends were sealed together,
forming a sleeve by sealing together the said side that was not laminated together as the product is deposited into the said film,
forming another seal above the portion of the said sleeve containing said product to form a package,
separating said package from said laminated film such that separating said package from said laminated film forms another seal at an end of said laminated film to form a bottom of a second package,
filling at least a portion of a said laminated film via an outlet in which the product is discharged horizontally into the space between the said two sheets on the side which was not laminated together starting from the end of the said two sheets where the said bottom of the second package was formed,
forming a sleeve by sealing together the said side that was not laminated together as the product is deposited into the said film,
forming another seal above the portion of the said sleeve containing said product to form a package,
separating said package from said laminated film such that separating said package from said laminated film forms another seal at an end of the said laminated film to form a bottom of a third package.

34. A method of forming a plurality of packages comprising:
providing a film having an inner surface and an outer surface and at least a first side edge and a second side edge, a top edge and a bottom edge,
positioning said film so that one portion of the inner surface is in a face to face relationship with a second portion of said inner surface and wherein said first edge and said second edge are also in a face to face relationship,
forming a seal on the bottom of said film,
sealing a portion of said first edge to a portion of said second edge at said bottom to and extruding away from said bottom to form a receiving area,
filling at least a portion of said receiving area via a horizontal outlet in which the product is discharged into the space formed by the inner surfaces of said film and the seals,
sealing said inner surfaces of said film in an area above said product to form a package having at least a bottom seal, a side seal and a top seal.

35. The method according to claim 34 wherein said film is a laminate of two sheets where the first sheet is in a face to face relationship with said second sheet and said sheets are secured to each other at a first side edge.
